(19) United States
(12) Patent Application Publication
(10) Pub. No.: US 2022/0319083 A1
(43) Pub. Date: Oct. 6, 2022

(54) SYSTEM AND METHOD FOR GENERATING AND PROVIDING CONTEXT-FENCED FILTERS TO MULTIMEDIA OBJECTS CAPTURED IN REAL-TIME

(71) Applicants: LAKSHMINATH REDDY DONDETI, San Jose, CA (US); VIDYA NARAYANAN, San Jose, CA (US)

(72) Inventors: LAKSHMINATH REDDY DONDETI, San Jose, CA (US); VIDYA NARAYANAN, San Jose, CA (US)

(21) Appl. No.: 17/709,543

(22) Filed: Mar. 31, 2022

Related U.S. Application Data
(60) Provisional application No. 63/170,513, filed on Apr. 4, 2021.

(51) Int. Cl. G06T 11/60; G06F 3/0482; G06V 10/70; H04N 5/265

(52) U.S. Cl. CPC G06T 11/60; G06F 3/0482; G06V 10/768; H04N 5/265; G06T 2200/24; G06F 3/017

(57) ABSTRACT

Exemplary embodiments of the present disclosure are directed towards a system and method to generate and provide context fence filters to multimedia objects captured in real-time, comprising computing devices configured to establish communication with server over network, computing devices comprises memory configured to store multimedia objects captured using camera; a context-fence filter generation module configured to detect first context fence parameters of the multimedia objects and identifies a first context fence state based on the detected context first fence parameters, the context-fence filter generation module configured to generate first contextual fence filters based on the first context fence state of the multimedia objects, whereby the context-fence filter generation module configured to store the first contextual fence filters in the memory and enables a user to apply the first contextual fence filters to the multimedia objects on the computing devices.

### CROSS-REFERENCE TO RELATED APPLICATIONS

This patent application claims priority benefit of U.S. Provisional Patent Application No. 63/170,513, entitled “METHOD AND APPARATUS FOR CREATING CONTEXT FENCED FILTERS”, filed on 4 Apr. 2021. The entire contents of the patent application are hereby incorporated by reference herein in its entirety.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### TECHNICAL FIELD

The disclosed subject matter relates generally to multimedia content filters enabled on computing devices in connected environments. More particularly, the present disclosure relates to a system and computer-implemented method for creating and providing filters with context fences to the captured multimedia objects on the computing device. The multimedia objects include photographs, images, videos selected, generated, or captured, or combinations thereof.

### BACKGROUND

Generally, social media allows users to create, send, receive, and share various types of information, including user-generated content such as texts, images, video clips, audio clips, and other types of digital media. Because of their collaborative nature and growing accessibility, social media platforms such as social networks have become a popular means by which many people share photos and other media content. Social networking platforms are constantly evolving to provide users with increasingly sophisticated functionalities.

Improvements in mobile phones with built-in cameras have enabled users to share images and video clips on social networks from any location. For instance, improved front-facing cameras in mobile phones allow users to capture high quality and vivid images, known as “selfies”. Mobile device applications (or apps) now provide various application features that work by interfacing with the device camera. Such device applications may allow taking and sharing images, including selfies.

Features that make the most impact and are actively used by users to share their images or videos are greatly desired. For instance, color filters are widely used to create more appealing and exciting photos. Similarly, frames may be added to the contents of a story, allowing users to provide context. Existing applications do not offer well-crafted filters and frames as a convenient feature for regular usage.

In the light of the aforementioned discussion, there exists a need for a certain system to generate and provide filters with context fences to the captured multimedia objects on the computing devices with novel methodologies that would overcome the above-mentioned challenges.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards a system and computer implemented method for generating and providing filters with context fences to the captured multimedia objects on the computing devices.

Another objective of the present disclosure is directed towards the terms ‘filter’ and ‘sticker’ refers to digital graphical elements (static, animated, dynamic, video graphic, and other related renditions and formats), and may be interchangeably used; any methods that are stated to be applicable for filters may also apply for stickers and vice-versa.

Another objective of the present disclosure is directed towards enabling the user to apply the filters and/or stickers to the multimedia objects of various formats. The various format may include static, animated, dynamic, video graphic, and other related renditions and formats as well.

Another objective of the present disclosure is directed towards enabling the user to apply the filters and/or stickers upon capturing the multimedia objects on the computing devices. However, the filters and/or stickers may be available prior to the multimedia objects being captured or recorded; the filters and/or stickers may appear on a camera view or independently against a graphical background.

According to an exemplary aspect of the present disclosure, the system comprising computing devices configured to establish communication with a server over a network, the computing devices comprises a memory configured to store multimedia objects captured using a camera.

According to another exemplary aspect of the present disclosure, the context-fence filter generation module configured to detect one or more first context fence parameters of the multimedia objects and identifies a first context fence state based on the detected one or more context first fence parameters, the context-fence filter generation module configured to generate one or more first contextual fence filters based on the first context fence state of the multimedia objects, whereby the context-fence filter generation module configured to store the one or more first contextual fence filters in the memory and enables a user to apply the one or more first contextual fence filters to the multimedia objects on the one or more computing devices.

According to another exemplary aspect of the present disclosure, context-fence filter controlling module configured to receive one or more second context fence parameters of the multimedia objects, whereby the context-fence filter controlling module configured to detect one or more second context fence parameters to identify a second context fence state of the multimedia objects.

According to another exemplary aspect of the present disclosure, the context-fence filter controlling module configured to generate one or more second contextual fence filters based on the identified second context fence state of the multimedia objects thereby enabling the user to apply at least one of the one or more first contextual filter and the one or more second contextual fence filters on the one or more computing devices.

According to another exemplary aspect of the present disclosure, the context-fence filter controlling module configured to detect an application state of at least one of the one or more first contextual fence filters; and the one or more second contextual fence filters on the multimedia objects thereby generating rewards to the user.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram depicting a schematic representation of a system and method to generate context fenced filters to multimedia objects on computing devices, in accordance with one or more exemplary embodiments.

FIG. 2 is a block diagram depicting an embodiment of the context fence filter generation module 114 on the computing devices and the context fence filter controlling module 116 on the server of shown in FIG. 1, in accordance with one or more exemplary embodiments.

FIG. 3 is a flow diagram depicting a method for generating context fenced filters to multimedia objects on the computing devices, in accordance with one or more exemplary embodiments.

FIG. 4 is a flow diagram depicting a method for generating context fenced filter template by the context fence filter generation module on the computing devices, in accordance with one or more exemplary embodiments.

FIG. 5 is a flow diagram depicting a method for customizing the context fenced filter template by specifying contextual parameters, in accordance with one or more exemplary embodiments.

FIG. 6 is a flow diagram depicting a method for displaying context fenced filters to the user, in accordance with one or more exemplary embodiments.

FIG. 7 is a flow diagram depicting a method for detecting a user within a context fence and alerting them with matching available filters, in accordance with one or more exemplary embodiments.

FIG. 8 is a flow diagram depicting a method for updating a context fence associated with a filter, in accordance with one or more exemplary embodiments.

FIG. 9 is a flow diagram depicting a method for generating rewards to the user, in accordance with one or more exemplary embodiments.

FIG. 10 is a flow diagram depicting a method for validating the context fences for active filters of the user, in accordance with one or more exemplary embodiments.

FIG. 11 is a block diagram illustrating the details of a digital processing system 1100 in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

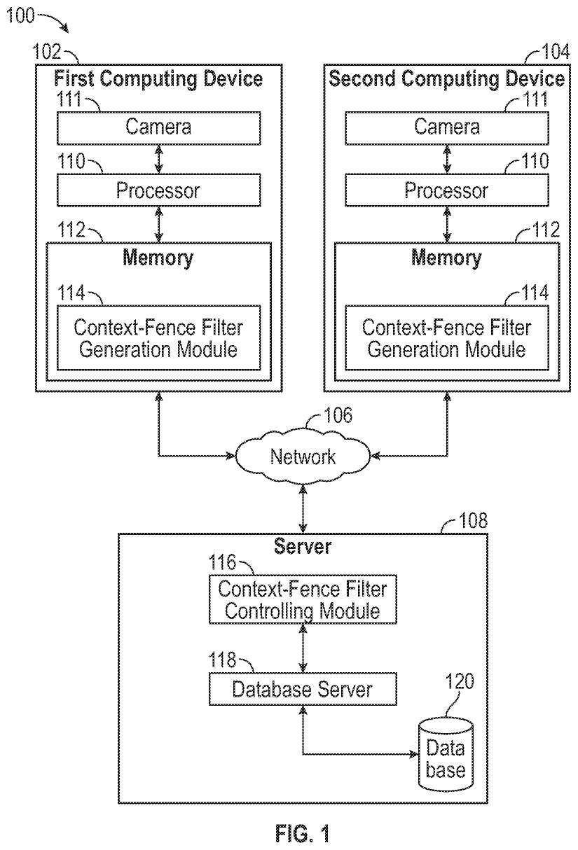

Referring to FIG. 1 is a block diagram 100 depicting a schematic representation of a system and method to generate context fenced filters to multimedia objects on computing devices, in accordance with one or more exemplary embodiments. The system 100 includes a first computing device 102, a second computing device 104, a network 106, a server 108, a processor 110, a camera 111, a memory 112, a context fence filter generation module 114, a context fence filter controlling module 116, a database server 118, and a database 120.

The computing devices 102, 104 may include users' devices. The computing devices 102, 104 may include, but is not limited to, a personal digital assistant, smartphones, personal computers, a mobile station, computing tablets, a handheld device, an internet enabled calling device, an internet enabled calling software, a telephone, a mobile phone, a digital processing system, and so forth. The computing devices 102, 104 may include the processor 110 in communication with a memory 112. The processor 110 may be a central processing unit or a graphics processing unit. The memory 112 is a combination of flash memory and random-access memory.

The computing devices 102, 104 may communicatively connect with the server 108 over the network 106. The network 106 may include, but not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure. The network 106 may be configured to provide access to different types of users.

Although the first computing device 102 or second computing device 104 is shown in FIG. 1, an embodiment of the system 100 may support any number of computing devices. The first computing device 102 or second computing device 104 may be operated by the users. The users may include, but not limited to, an individual, a client, an operator, and the like. The first computing device 102 or second computing device 104 supported by the system 100 is realized as a computer-implemented or computer-based device having the hardware or firmware, software, and/or processing logic needed to carry out the computer-implemented methodologies described in more detail herein.

In accordance with one or more exemplary embodiments of the present disclosure, the computing devices 102, 104 includes the camera 111 may be configured to enable the user to capture the multimedia objects using the processor 110. The computing devices 102, 104 may include the context fence filter generation module 114 in the memory 112. The context fence filter generation module 114 may be configured to create and provide context fenced filters to multimedia objects on computing devices. The multimedia objects may include, but not limited to static images, photographs, dynamic images, photographs, looping images, looping videos, animated text, animated graphics, and other similar renditions and formats. The context fence filter generation module 114 may be any suitable applications downloaded from GOOGLE PLAY® (for Google Android devices), Apple Inc.'s APP STORE® (for Apple devices), or any other suitable database. The context fence filter generation module 114 may be desktop application which runs on Windows or Linux or any other operating system and may be downloaded from a webpage or a CD/USB stick etc. In some embodiments, the context fence filter generation module 114 may be software, firmware, or hardware that is integrated into the computing devices 102, 104. The computing devices 102, 104 may present a web page to the user by way of a browser, wherein the webpage comprises a hyper-link may direct the user to uniform resource locator (URL).

The server 108 may include the context fence filter controlling module 116, the database server 118, the database 120. The context fence filter controlling module 116 may be configured to perform filter selection operations. The context fence filter controlling module 116 may also be configured to provide server-side functionality via the network 106 to one or more users. The database server 118 may be configured to access the one or more databases. the database 120 may be configured to store user filters and interactions between the modules of the context fence filter generation module 114.

The context-fence filter generation module 114 may be configured to detect one or more first context fence parameters of the multimedia objects and identifies a first context fence state based on the detected one or more context first fence parameters. The one or more context first fence parameters may include a user, an object, an activity, and a type of place. For example, in the case of the object, the context fence is around the object. The object may be static or mobile. If mobile, as the object moves, the context fence (and hence, any filter with that context fence) moves with the object. In this case, the filter would be active. For example, a food truck may be context fenced to have a filter along the lines of “Tacos @ Frida's”—people near the food truck, irrespective of its location, can use the filter on a photo. As the food truck moves, its context fence is updated so that the filter remains active at the correct location. Other examples of such filters may be “Quick stop @ TheNailTruck”, “The O'Hara family Tesla on a roadtrip”, etc. For example, in the case of the activity, the context fence is around an activity such as driving or shopping or biking, etc. A filter with such a context fence becomes active when the user is performing the stated activity (or for a while after an activity was completed). For example, a filter set up to be active around a race may provide dynamic information such as “Mile 12, going strong!”, “Proud finisher of the 80 mi Oregon bike ride!”, etc. As another example, a filter set up to be active when the user is driving may say something along the lines of “Not supposed to be taking a photo right now!”. A parent or a friend may set up such a filter for a user to send a message about the user using the phone while in an automobile. Other examples may include things like “Watching the re-run of Game of Thrones”, “Chilling at Susie's”, “Shopped for 10 hours straight!” and so on. For example, in the case of the type of place, in this case, the context fence is set up around a type of place, such as a coffeeshop, grocery store, etc. For example, a filter set up to remind Brad about getting a drink for a friend, Jen, may say something along the lines of “Pick up coffee for Jen”. Such a filter can be set up to appear when Brad is near or at a coffeeshop. Other examples may include reminders to pick up things at a grocery store, notes left at parks, etc. other contexts may include time, weather, etc.

The context-fence filter generation module 114 may be configured to generate one or more first contextual fence filters based on the first context fence state of the multimedia objects. The context-fence filter generation module 114 configured to store the one or more first contextual fence filters in the memory and enables the user to apply the one or more first contextual fence filters to the multimedia objects on the one or more computing devices.

The context-fence filter controlling module 116 may be configured to receive one or more second context fence parameters of the multimedia objects. The context-fence filter controlling module 116 may be configured to detect one or more second context fence parameters to identify a second context fence state of the multimedia objects. The context-fence filter controlling module 116 may be configured to generate one or more second contextual fence filters based on the identified second context fence state of the multimedia objects. The context-fence filter controlling module 116 may be configured to detect an application state of at least one of: the one or more first contextual fence filters; and the one or more second contextual fence filters on the multimedia objects.

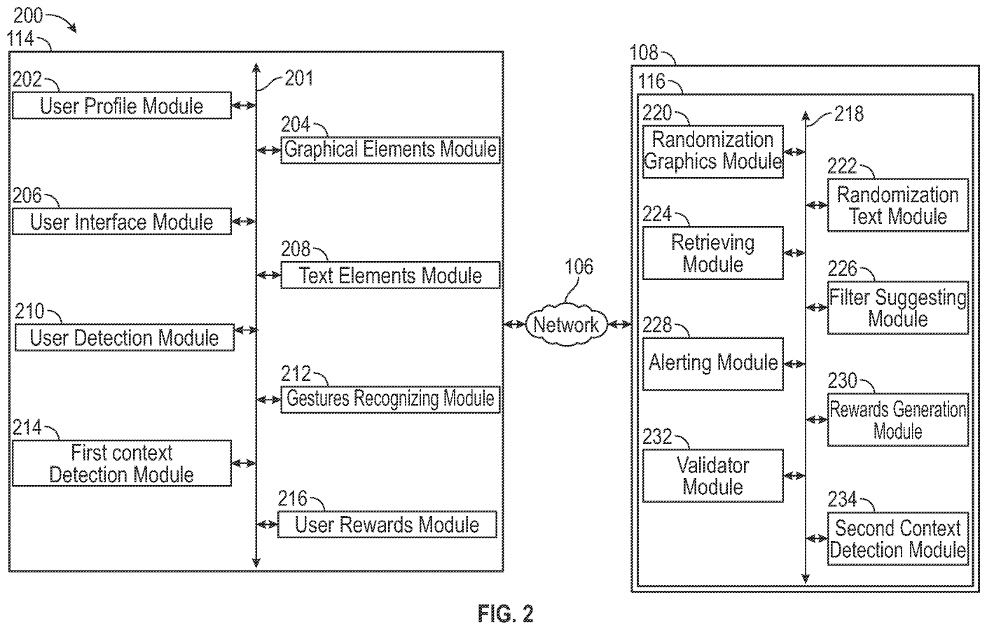

Referring to FIG. 2 is a block diagram 200 depicting an embodiment of the context fence filter generation module 114 on the computing devices and the context fence filter controlling module 116 on the server of shown in FIG. 1, in accordance with one or more exemplary embodiments. The context fence filter generation module 114 includes a bus 201, a user profile module 202, a graphical elements module 204, a user interface module 206, a text elements module 208, a user detection module 210, a gesture recognizing module 212, a first context detection module 214, a user rewards module 216. The bus 201 may include a path that permits communication among the modules of the context fence filter generation module 114 installed on the computing devices 102, 104. The term “module” is used broadly herein and refers generally to a program resident in the memory 112 of the computing devices 102, 104.

The user profile module 202 may be configured to store basic details of the user and the personal information of the user. The user profile module 202 may be configured to store the multimedia content of the user on the database individually based on the user profiles. The graphical elements module 204 may be configured to enable the user to choose one or more graphical elements for generating a filter template. The one or more graphical elements may include a background, one or more containers of text, the one or more graphical elements may represent the category or topic of the filter.

The text elements module 208 may be configured to enable the user to choose one or more textual elements for the filter template. The textual elements may include quotable quotes, greetings, slang, everyday expressions, and other text lines related to the filter template. For example, the filter template relates to movies the text lines may include related to asking friends to go out to a movie with them. Alternatively, a filter template relating to a birthday may include birthday related lines, and so forth.

The first context detection module 214 may be configured to provide one or more context elements for the filter template. The one or more context elements may include graphical or text elements that capture something about the context. The context elements may represent an activity such as shopping, driving, being outdoors, a place such as home, work, class, restaurant, store, a mobile service such as food truck, mobile nail spa, an environmental condition such as dark, bright, loud, quiet, a person such as the user or his or her friends, and the like. The first context detection module 214 may be configured to update the context fences of the filters based on the changes of contexts. The first context detection module 214 may be configured to retrieve the user context. The first context detection module 214 may be configured to monitor contexts of the user. The monitoring of context may involve recording various signals from the device and computing contexts such as activity of the user, place of the user and so forth. The first context detection module 214 may be configured to add context fence parameters to the filter template. The context fence parameters may indicate the type of contexts around which the filter is to be active. The context fence parameters may specify the contents a user, an object, an activity, a type of place, time, weather, and the like. In addition, context fences may involve multiple contexts, the contexts may include “Coffeeshop” OR “grocery store”, “Biking” AND “with Alice”.

The user interface module 206 may be configured to display one or more filter templates to the user. The user detection module 210 may be configured to determine the user's presence in the context fence of relevance. The user rewards module 216 may be configured to store the rewards of the users. The gesture recognizing module 212 may be configured to determine the hand gestures of the user. The gestures recognizing module 212 may be configured to enable the user to edit the one or more filter templates. The option editing template may involve entering text or graphical elements that are marked up for editing. For example, the user may edit the default text provided in the template to his or her own words. The user may further upload one or more graphical elements and place it as part of the filter. The area of edits is detected, and the filter elements may combine to create the custom filter itself.

In accordance with one or more exemplary embodiments of the present disclosure, the context fence filter controlling module 116 includes a bus 218, a randomization graphics module 220, a randomization text module 222, a retrieving module 224, a filter suggesting module 226, an alerting module 228, a rewards generation module 230, a validator module 232, a second context detection module 234. The bus 218 may include a path that permits communication among the modules of the context fence filter controlling module 116 installed on the sever 108.

In accordance with one or more exemplary embodiments of the present disclosure, the randomization graphics module 220 may be configured to provide the random set of graphical elements from a pool of available graphical elements of each category. The random set of graphical elements may include several background graphical layers.

In accordance with one or more exemplary embodiments of the present disclosure, the randomization text module 222 may be configured to provide the random set of text elements from a pool of available text elements relates to the topic of the filter template. For example, a birthday related filter may include lines such as “Happy Birthday”, “Many happy returns”, “A new chapter begins” and so forth.

The second context detection module 234 may be configured to retrieve the matching context fenced filters to the user captured photos. The second context module 234 may be configured to detect one or more second context fence parameters to identify a second context fence state of the multimedia objects.

In accordance with one or more exemplary embodiments of the present disclosure, the retrieving module 224 may be configured to retrieve the one or more filter templates based on the user's interests from the database through the database server. The retrieving module 224 may be configured to retrieve the users that match the revised context fences of the filter. The retrieving module 224 may be configured to personalize the context elements to the user by retrieving the user profile and the user's context.

In accordance with one or more exemplary embodiments of the present disclosure, the filter suggesting module 226 may be configured to offering suggestions to assist the user in editing the editable fields. The suggestions offering may be based on the user profile and/or context. For instance, a name field may be auto populated with the user's name or a friend's name. A date field may be populated with the current date or the user's birthday or any other event.

In accordance with one or more exemplary embodiments of the present disclosure, the alerting module 228 may be configured to alert the user with the matching filters. The step of alerting may involve sending a message to the user, sending a notification, playing a sound, some indication in the user interface such as an icon.

In accordance with one or more exemplary embodiments of the present disclosure, the rewards generation module 230 may be configured to provide rewards to the user based on use of the contextual filters. The rewards generation module 230 may be configured to provide rewards to owner of the contextual filters based on use of the filters by the users.

In accordance with one or more exemplary embodiments of the present disclosure, the validator module 232 may be configured to validating the context fences for active filters of the user.

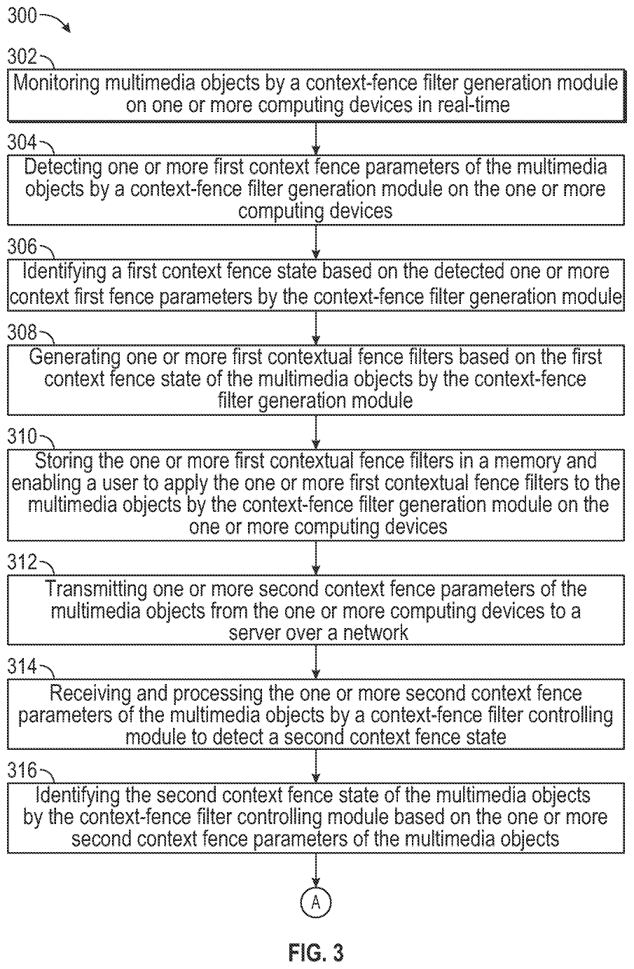

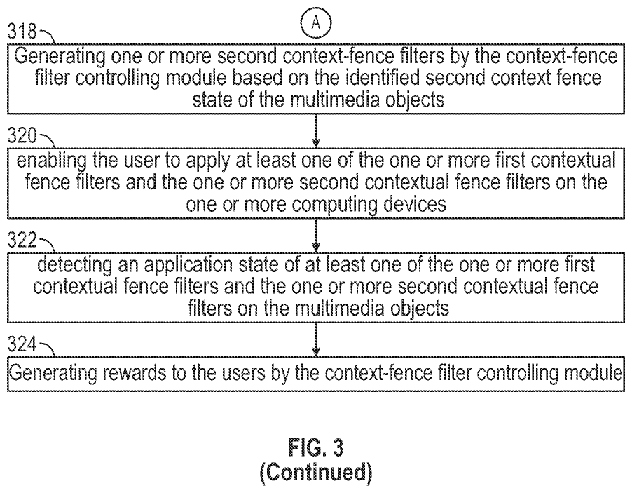

Referring to FIG. 3 is a flow diagram 300 depicting a method for generating context fenced filters to multimedia objects on the computing devices, in accordance with one or more exemplary embodiments. The method 300 may be carried out in the context of the details of FIG. 1, and FIG. 2. However, the method 300 may also be carried out in any desired environment. Further, the aforementioned definitions may equally apply to the description below.

The method commences at step 302, monitoring multimedia objects by the context-fence filter generation module on one or more computing devices in real-time. Thereafter at step 304, detecting one or more first context fence parameters of the multimedia objects by the context-fence filter generation module on the one or more computing devices. Thereafter at step 306, identifying the first context fence state based on the detected one or more context first fence parameters by the context-fence filter generation module. Thereafter at step 308, generating one or more first contextual fence filters based on the first context fence state of the multimedia objects by the context-fence filter generation module. Thereafter at step 310, storing the one or more first contextual fence filters in the memory and enabling the user to apply the one or more first contextual fence filters to the multimedia objects by the context-fence filter generation module on the one or more computing devices. Thereafter at step 312, transmitting one or more second context fence parameters of the multimedia objects from the one or more computing devices to the server over the network. Thereafter at step 314, receiving and processing the one or more second context fence parameters of the multimedia objects by the context-fence filter controlling module to detect the second context fence state. Thereafter at step 316, identifying the second context fence state of the multimedia objects by the context-fence filter controlling module based on the one or more second context fence parameters of the multimedia objects. Thereafter at step 318, generating one or more second context-fence filters by the context-fence filter controlling module based on the identified second context fence state of the multimedia objects. Thereafter at step 320, enabling the user to apply at least one of the one or more first contextual fence filters and the one or more second contextual fence filters on the one or more computing devices. Thereafter at step 322, detecting the application state of at least one of the one or more first contextual fence filters and the one or more second contextual fence filters on the multimedia objects. Thereafter at step 324, generating rewards to the users by the context-fence filter controlling module.

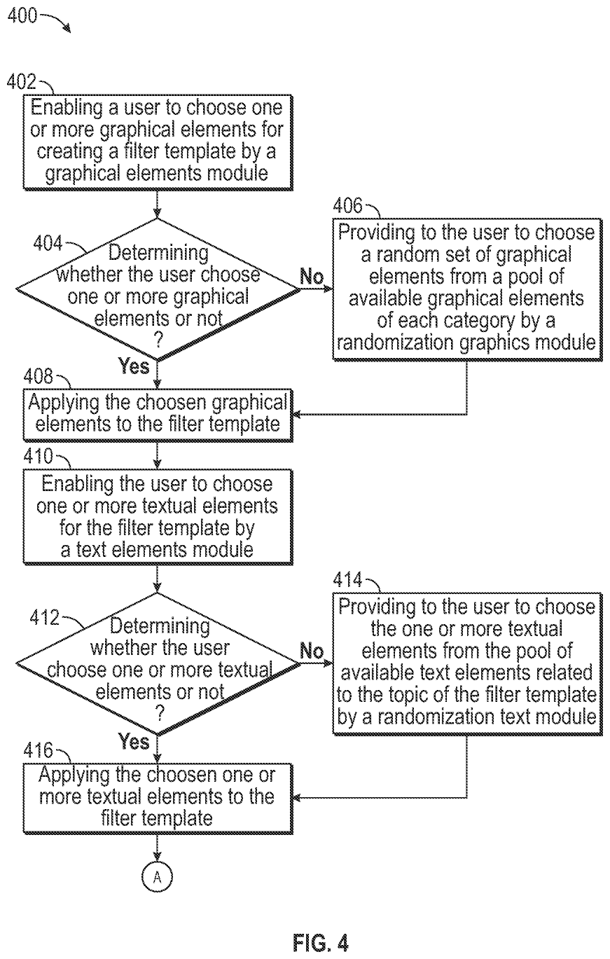

Referring to FIG. 4 is a flow diagram 400 depicting a method for generating context fenced filter template by the context fence filter generation module on the computing devices, in accordance with one or more exemplary embodiments. The method 400 may be carried out in the context of the details of FIG. 1, FIG. 2, and FIG. 3. However, the method 400 may also be carried out in any desired environment. Further, the aforementioned definitions may equally apply to the description below.

The method commences at step 402, enabling the user to choose one or more graphical elements for creating the filter template by the graphical elements module. Determining whether the user chose the one or more graphical elements or not, at step 404. If answer at step 404 is No, the method continues at step 406, providing to the user to choose the random set of graphical elements from the pool of available graphical elements of each category by the randomization graphics module. If answer at step 404 is Yes, the method continues at step 408, applying the chosen graphical elements to the filter template. Thereafter at step 410, enabling the user to choose the one or more textual elements for the filter template by the text elements module. Determining whether the user choose the one or more textual elements or not, at step 412. If answer at step 412 is No, the method continues at step 414, providing to the user to choose the one or more textual elements from the pool of available text elements related to the topic of the filter template by the randomization text module. If answer at step 412 is Yes, the method continues at step 416, applying the chosen one or more textual elements to the filter template. Thereafter at step 418, creating one or more context elements for the filter template by the first context detection module. Determining whether the one or more context elements were created or not, at step 420. If answer at step 420 is No, the method continues at step 422, personalizing the context elements to the user by retrieving the user profile and the user's context by the retrieving module. If answer at step 420 is Yes, the method continues at step 424, applying the one or more context elements to the filter template. Thereafter at step 426, adding the context fence parameters to the filter template by the first context detection module. Thereafter at step 428, storing the created filter template on the database through the database server.

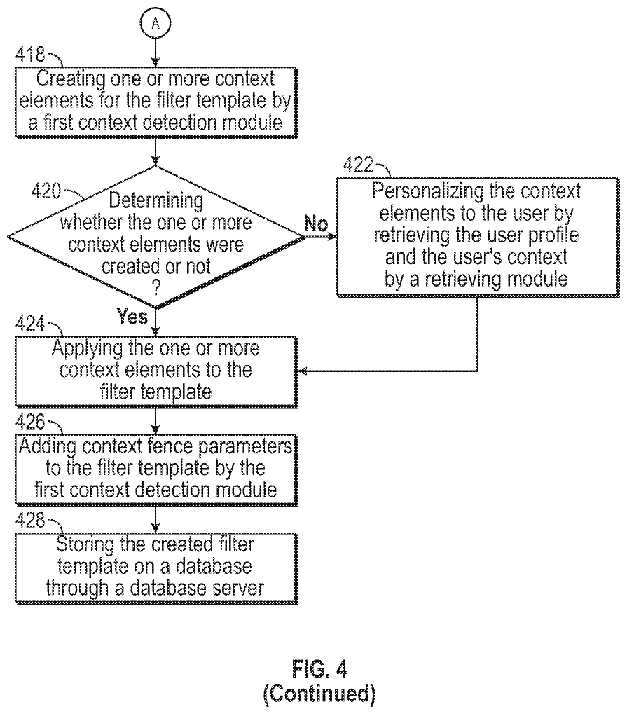

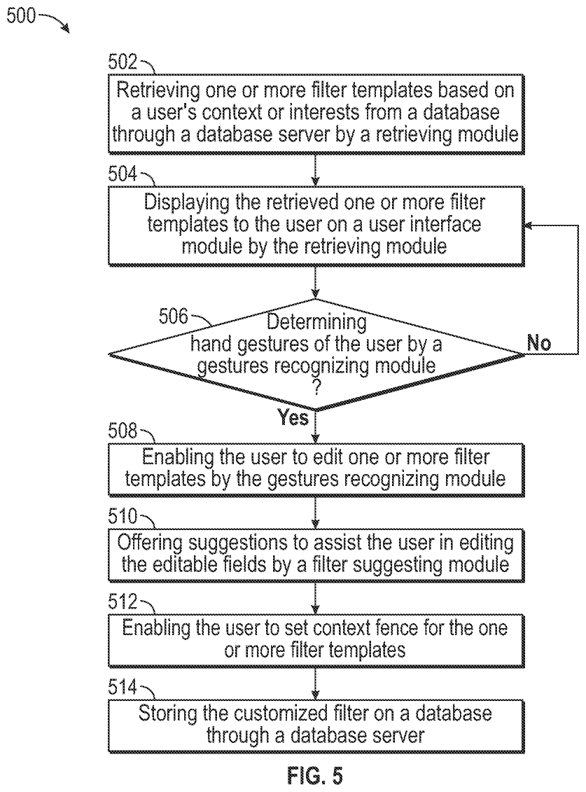

Referring to FIG. 5 is a flow diagram 500 depicting a method for customizing the context fenced filter template by specifying contextual parameters. The method 500 may be carried out in the context of the details of FIG. 1, FIG. 2, FIG. 3, and FIG. 4. However, the method 500 may also be carried out in any desired environment. Further, the aforementioned definitions may equally apply to the description below.

The method commences at step 502, retrieving the one or more filter templates based on the user's context or interests from the database through the database server by the retrieving module. Thereafter at step 504, displaying the retrieved one or more filter templates to the user on the user interface module by the retrieving module. Determining hand gestures of the user by the gestures recognizing module, at step 506. If answer at step 506 is No, the method reverts at step 504. If answer at step 506 is Yes, the method continues at step 508, enabling the user to edit the one or more filter templates by the gestures recognizing module. Thereafter at step 510, offering suggestions to assist the user in editing the editable fields by the filter suggesting module. Thereafter at step 512, enabling the user to set context fence for the one or more filter templates. Thereafter at step 514, storing the customized filter on the database through the database server.

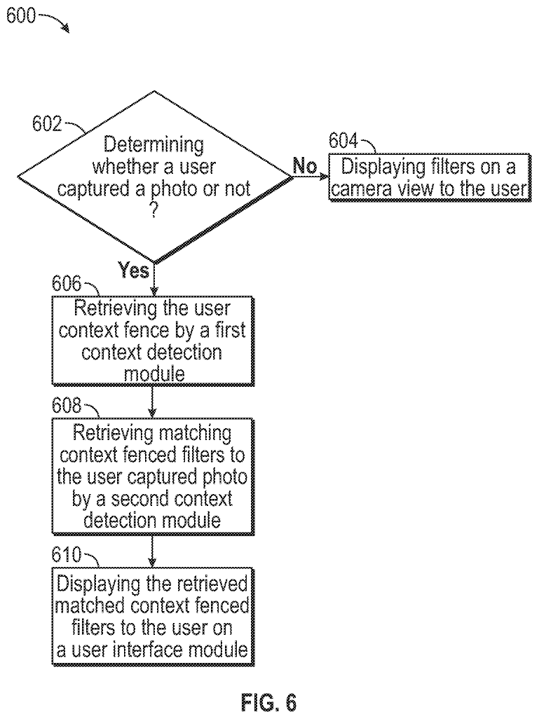

Referring to FIG. 6 is a flow diagram 600 depicting a method for displaying context fenced filters to the user, in accordance with one or more exemplary embodiments. The method 600 may be carried out in the context of the details of FIG. 1, FIG. 2, FIG. 3, FIG. 4, and FIG. 5. However, the method 600 may also be carried out in any desired environment. Further, the aforementioned definitions may equally apply to the description below.

Determining whether the user captured the photo or not, at step 602. If answer at step 602 is Yes, the method continues at step 606, retrieving the user context fence by the first context detection module. Thereafter at step 608, retrieving the matching context fenced filters to the user captured photo by the second context detection module. Thereafter at step 610, displaying the retrieved matched context fenced filters to the user on the user interface module. If answer at step 602 is No, the method continues at step 604, displaying the filters on the camera view to the user.

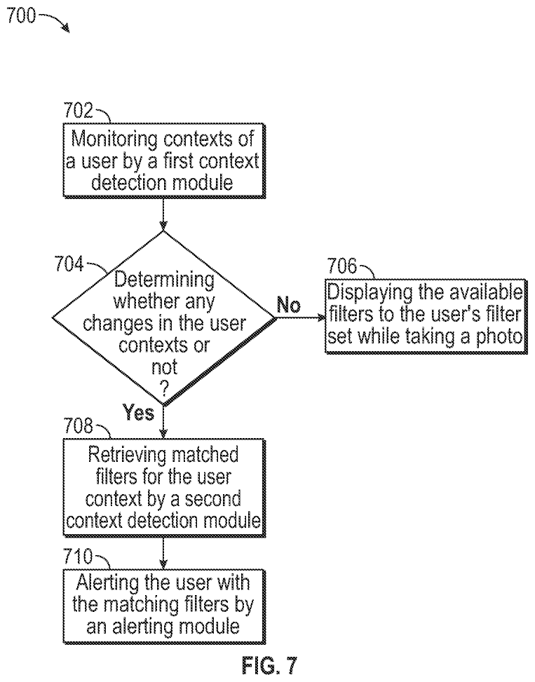

Referring to FIG. 7 is a flow diagram 700 depicting a method for detecting a user within a context fence and alerting them with matching available filters, in accordance with one or more exemplary embodiments. The method 700 may be carried out in the context of the details of FIG. 1, FIG. 2, FIG. 3, FIG. 4, FIG. 5, and FIG. 6. However, the method 700 may also be carried out in any desired environment. Further, the aforementioned definitions may equally apply to the description below.

The method commences at step 702, monitoring the contexts of the user by the first context detection module. Determining whether any changes in the user contexts or not, at step 704. If answer at step 704 is No, the method continues at step 706, displaying the available filters to the user's filter set while taking the photo. If answer at step 704 is Yes, the method continues at step 708, retrieving the matched filters for the user context by the second context detection module. Thereafter at step 710, alerting the user with the matching filters by the alerting module.

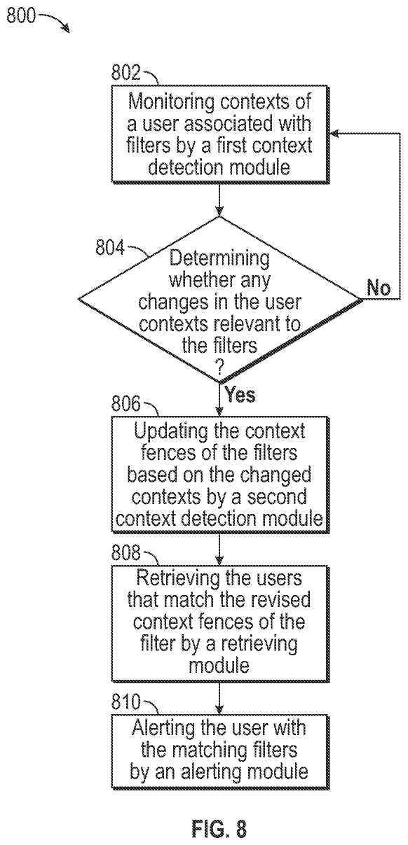

Referring to FIG. 8 is a flow diagram 800 depicting a method for updating a context fence associated with a filter, in accordance with one or more exemplary embodiments. The method 800 may be carried out in the context of the details of FIG. 1, FIG. 2, FIG. 3, FIG. 4, FIG. 5, FIG. 6, and FIG. 7. However, the method 800 may also be carried out in any desired environment. Further, the aforementioned definitions may equally apply to the description below.

The method commences at step 802, monitoring contexts of the user associated with filters by the first context detection module. Determining whether any changes in the user contexts relevant to the filters, at step 804. If answer at step 804 is Yes, the method continues at step 806, updating the context fences of the filters based on the changed contexts by the second context detection module. Thereafter at step 808, retrieving the users that match the revised context fences of the filter by the retrieving module. Thereafter at step 810, alerting the users with the matching filters by the alerting module. If answer at step 804 is No, the method reverts at step 802.

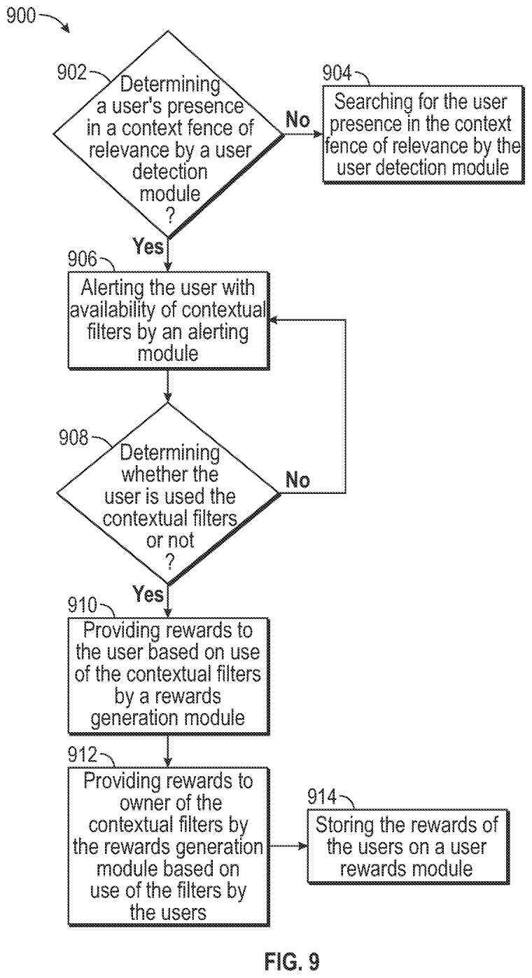

Referring to FIG. 9 is a flow diagram 900 depicting a method for generating rewards to the user in accordance with one or more exemplary embodiments. The method 900 may be carried out in the context of the details of FIG. 1, FIG. 2, FIG. 3, FIG. 4, FIG. 5, FIG. 6, FIG. 7, and FIG. 8. However, the method 900 may also be carried out in any desired environment. Further, the aforementioned definitions may equally apply to the description below.

Determining the user's presence in the context fence of relevance by the user detection module, at step 902. If answer at step 902 is No, the method continues at step 904, searching for the user presence in the context fence of relevance by the user detection module. If answer at step 902 is Yes, the method continues at step 906, alerting the user with availability of contextual filters by the alerting module. Determining whether the user is used the contextual filters or not, at step 908. If answer at step 908 is Yes, the method continues at step 910, providing rewards to the user based on use of the contextual filters by the rewards generation module. Thereafter at step 912, providing rewards to owner of the contextual filters by the rewards generation module based on use of the filters by the users. Thereafter at step 914, storing the rewards of the users on the user rewards module. If answer at step 908 is No, the method reverts at step 906.

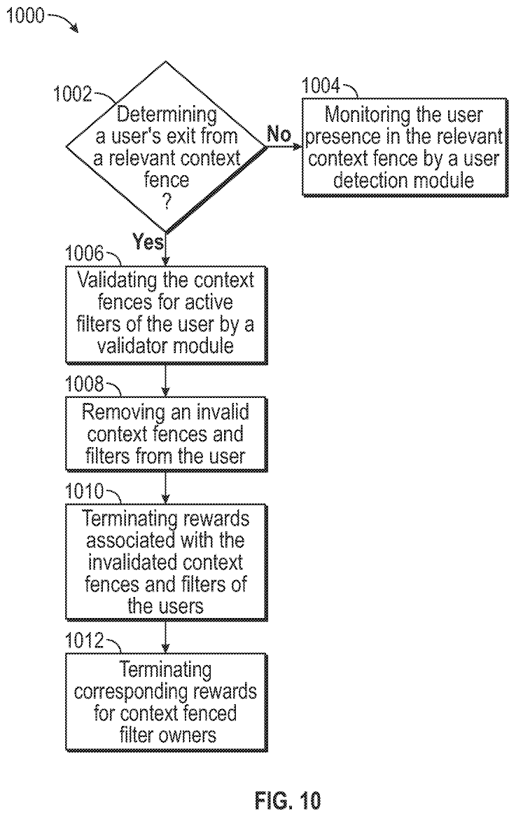

Referring to FIG. 10 is a flow diagram 1000 depicting a method for validating the context fences for active filters of the user, in accordance with one or more exemplary embodiments. The method 1000 may be carried out in the context of the details of FIG. 1, FIG. 2, FIG. 3, FIG. 4, FIG. 5, FIG. 6, FIG. 7, FIG. 8, and FIG. 9. However, the method 1000 may also be carried out in any desired environment. Further, the aforementioned definitions may equally apply to the description below.

Determining the user's exit from the relevant context fence, at step 1002. If answer at step 1002 is No, the method continues at step 1004, monitoring the user presence in the relevant context fence by the user detection module. If answer at step 1002 is Yes, the method continues at step 1006, validating the context fences for active filters of the user by the validator module. Thereafter at step 1008, removing the invalid context fences and filters from the user. Thereafter at step 1010, terminating rewards associated with the invalidated context fences and filters of the users. Thereafter at step 1012, terminating the corresponding rewards for the context fenced filter owners.

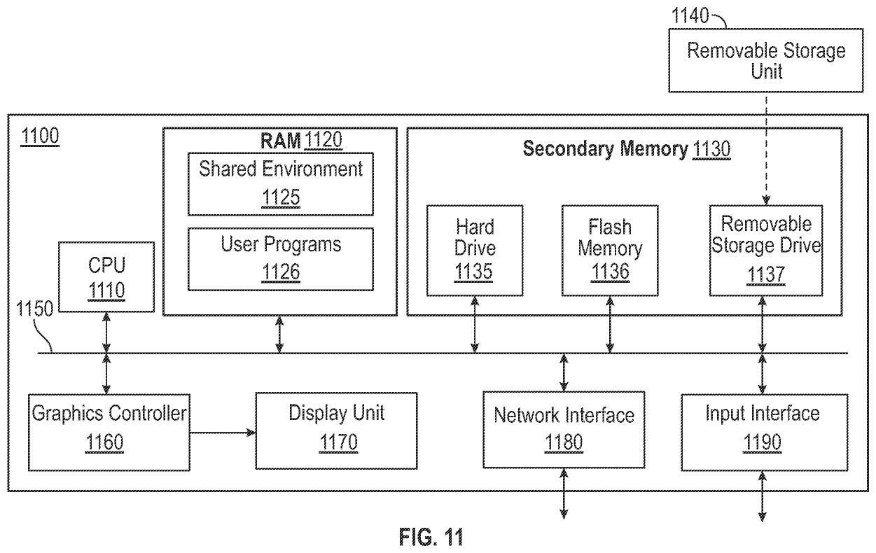

Referring to FIG. 11 is a block diagram 1100 illustrating the details of a digital processing system 1100 in which various aspects of the present disclosure are operative by execution of appropriate software instructions. The Digital processing system 1100 may correspond to the first computing devices 102, 104 (or any other system in which the various features disclosed above can be implemented).

Digital processing system 1100 may contain one or more processors such as a central processing unit (CPU) 1110, random access memory (RAM) 1120, secondary memory 1130, graphics controller 1160, display unit 1170, network interface 1180, and input interface 1190. All the components except display unit 1170 may communicate with each other over communication path 1150, which may contain several buses as is well known in the relevant arts. The components of FIG. 11 are described below in further detail.

CPU 1110 may execute instructions stored in RAM 1120 to provide several features of the present disclosure. CPU 1110 may contain multiple processing units, with each processing unit potentially being designed for a specific task. Alternatively, CPU 1110 may contain only a single general-purpose processing unit.

RAM 1120 may receive instructions from secondary memory 1130 using communication path 1150. RAM 1120 is shown currently containing software instructions, such as those used in threads and stacks, constituting shared environment 1125 and/or user programs 1126. Shared environment 1125 includes operating systems, device drivers, virtual machines, etc., which provide a (common) run time environment for execution of user programs 1126.

Graphics controller 1160 generates display signals (e.g., in RGB format) to display unit 1170 based on data/instructions received from CPU 1110. Display unit 1170 contains a display screen to display the images defined by the display signals. Input interface 1190 may correspond to a keyboard and a pointing device (e.g., touch-pad, mouse) and may be used to provide inputs. Network interface 1180 provides connectivity to a network (e.g., using Internet Protocol), and may be used to communicate with other systems (such as those shown in FIG. 1) connected to the network 106.

Secondary memory 1130 may contain hard drive 1135, flash memory 1136, and removable storage drive 1137. Secondary memory 1130 may store the data software instructions (e.g., for performing the actions noted above with respect to the Figures), which enable digital processing system 1100 to provide several features in accordance with the present disclosure.

Some or all of the data and instructions may be provided on removable storage unit 1140, and the data and instructions may be read and provided by removable storage drive 1137 to CPU 1110. Floppy drive, magnetic tape drive, CD-ROM drive, DVD Drive, Flash memory, removable memory chip (PCMCIA Card, EEPROM) are examples of such removable storage drive 1137.

Removable storage unit 1140 may be implemented using medium and storage format compatible with removable storage drive 1137 such that removable storage drive 1137 can read the data and instructions. Thus, removable storage unit 1140 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 1140 or hard disk installed in hard drive 1135. These computer program products are means for providing software to digital processing system 1100. CPU 1110 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 1130. Volatile media includes dynamic memory, such as RAM 1120. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 1150. Transmission media can also take the form of acoustic or light waves, such as those generated during radio-wave and infra-red data communications.

According to an exemplary aspect of the present disclosure, the system comprising computing devices 102, 104 configured to establish communication with a server 108 over a network 106, the computing devices 102, 104 comprises a memory 112 configured to store multimedia content captured using a camera 111.

According to another exemplary aspect of the present disclosure, the context-fence filter generation module 114 configured to detect one or more first context fence parameters of the multimedia objects and identifies a first context fence state based on the detected one or more context first fence parameters, the context-fence filter generation module 114 configured to generate one or more first contextual fence filters based on the first context fence state of the multimedia objects, whereby the context-fence filter generation module 114 configured to store the one or more first contextual fence filters in the memory 112 and enables a user to apply the one or more first contextual fence filters to the multimedia objects on the one or more computing devices 102, 104.

According to another exemplary aspect of the present disclosure, context-fence filter controlling module 116 configured to receive one or more second context fence parameters of the multimedia objects, the context-fence filter controlling module 116 configured to detect one or more second context fence parameters to identify a second context fence state of the multimedia objects.

According to another exemplary aspect of the present disclosure, the context-fence filter controlling module 116 configured to generate one or more second contextual fence filters based on the identified second context fence state of the multimedia objects thereby enabling the user to apply at least one of: the one or more first contextual filter; and the one or more second contextual fence filters on the one or more computing devices.

According to another exemplary aspect of the present disclosure, the context-fence filter controlling module 116 configured to detect an application state of at least one of: the one or more first contextual fence filters; and the one or more second contextual fence filters on the multimedia objects thereby generating rewards to the user.

According to another exemplary aspect of the present disclosure, a method for generating and providing context fence filters to multimedia objects captured in real-time, comprising: monitoring multimedia objects by a context-fence filter generation module 114 on one or more computing devices in real-time.

According to another exemplary aspect of the present disclosure, detecting one or more first context fence parameters of the multimedia objects by a context-fence filter generation module 114 on the one or more computing devices.

According to another exemplary aspect of the present disclosure, identifying a first context fence state based on the detected one or more context first fence parameters by the context-fence filter generation module 114.

According to another exemplary aspect of the present disclosure, generating one or more first contextual fence filters based on the first context fence state of the multimedia objects by the context-fence filter generation module 114.

According to another exemplary aspect of the present disclosure, storing the one or more first contextual fence filters in a memory and enabling a user to apply the one or more first contextual fence filters to the multimedia objects by the context-fence filter generation module 114 on the one or more computing devices.

According to another exemplary aspect of the present disclosure, transmitting one or more second context fence parameters of the multimedia objects from the one or more computing devices to a server 108 over a network 106.

According to another exemplary aspect of the present disclosure, receiving and processing the one or more second context fence parameters of the multimedia objects by a context-fence filter controlling module 116 to detect a second context fence state.

According to another exemplary aspect of the present disclosure, identifying the second context fence state of the multimedia objects by the context-fence filter controlling module 116 based on the one or more second context fence parameters of the multimedia objects.

According to another exemplary aspect of the present disclosure, generating one or more second context-fence filters by the context-fence filter controlling module 116 based on the identified second context fence state of the multimedia objects.

According to another exemplary aspect of the present disclosure, enabling the user to apply at least one of: the one or more first contextual fence filters; and the one or more second contextual fence filters on the one or more computing devices.

According to another exemplary aspect of the present disclosure, detecting an application state of at least one of: the one or more first contextual fence filters; and the one or more second contextual fence filters on the multimedia objects thereby generating rewards to the user by the context-fence filter controlling module 116.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A system configured to generate and provide context fence filters to multimedia objects captured in real-time, comprising:
one or more computing devices configured to establish communication with a server over a network, whereby the one or more computing device comprises a memory configured to store multimedia objects captured using a camera;
a context-fence filter generation module configured to detect one or more first context fence parameters of the multimedia objects and identifies a first context fence state based on the detected one or more context first fence parameters, the context-fence filter generation module configured to generate one or more first contextual fence filters based on the first context fence state of the multimedia objects, whereby the context-fence filter generation module configured to store the one or more first contextual fence filters in the memory and enables a user to apply the one or more first contextual fence filters to the multimedia objects on the one or more computing devices;
the server comprises a context-fence filter controlling module configured to receive one or more second context fence parameters of the multimedia objects, whereby the context-fence filter controlling module configured to detect one or more second context fence parameters to identify a second context fence state of the multimedia objects;
the context-fence filter controlling module configured to generate one or more second contextual fence filters based on the identified second context fence state of the multimedia objects thereby enabling the user to apply at least one of: the one or more first contextual filter; and the one or more second contextual fence filters on the one or more computing devices; and
the context-fence filter controlling module configured to detect an application state of at least one of: the one or more first contextual fence filters; and the one or more second contextual fence filters on the multimedia objects thereby generating rewards to the user.

2. The system of claim 1, wherein the context-fence filter generation module comprises a graphical elements module configured to enable the user to choose one or more graphical elements for creating filter templates.

3. The system of claim 1, wherein the context-fence filter generation module comprises a text elements module configured to enable the user to choose one or more textual elements for creating the filter templates.

4. The system of claim 1, wherein the context-fence filter generation module comprises a first context detection module configured to provide one or more context elements for generating the filter templates.

5. The system of claim 4, wherein the first context detection module configured to add context fence parameters for generating the filter templates.

6. The system of claim 4, wherein the first context detection module configured to monitor and retrieve the user context fences.

7. The system of claim 1, wherein the context-fence filter generation module comprises a user detection module configured to identify the user presence in the context fence of relevance.

8. The system of claim 1, wherein the context-fence filter generation module comprises a gestures recognizing module configured to identify hand gestures of the user and enable the user to edit the one or more filter templates.

9. The system of claim 1, wherein the context-fence filter controlling module comprises a randomization graphics module configured to allow the user to choose a random set of graphical elements from a pool of available graphical elements of each category.

10. The system of claim 1, wherein the context-fence filter controlling module comprises a randomization text module configured to allow the user to choose the one or more textual elements from the pool of available text elements related to the topic of the filter template.

11. The system of claim 1, wherein the context-fence filter controlling module comprises a retrieving module configured to personalize the context elements to the user by retrieving the user profile.

12. The system of claim 11, wherein the retrieving module is configured to retrieve the users that match the revised context fences of the filter.

13. The system of claim 1, wherein the context-fence filter controlling module comprises a second context module configured to detect one or more second context fence parameters to identify a second context fence state of the multimedia objects.

14. The system of claim 1, wherein the context-fence filter controlling module comprises a filter suggesting module configured to offer suggestions and assist the user in editing the editable fields.

15. The system of claim 1, wherein the context-fence filter controlling module comprises an alerting module configured to alert the user with the matching filters.

16. The system of claim 1, wherein the context-fence filter controlling module comprises a rewards generation module configured to provide rewards to the user based on the use of the contextual filters.

17. The system of claim 16, wherein the rewards generation module configured to provide the rewards to owner of the contextual filters based on use of the filters by the users.

18. The system of claim 1, wherein the context-fence filter controlling module comprises a validator module configured to validate the user context fences of active filters.

19. A method for generating and providing context fence filters to multimedia objects captured in real-time, comprising:
monitoring multimedia objects by a context-fence filter generation module on one or more computing devices in real-time;
detecting one or more first context fence parameters of the multimedia objects by a context-fence filter generation module on the one or more computing devices;
identifying a first context fence state based on the detected one or more context first fence parameters by the context-fence filter generation module;
generating one or more first contextual fence filters based on the first context fence state of the multimedia objects by the context-fence filter generation module;
storing the one or more first contextual fence filters in a memory and enabling a user to apply the one or more first contextual fence filters to the multimedia objects by the context-fence filter generation module on the one or more computing devices;
transmitting one or more second context fence parameters of the multimedia objects from the one or more computing devices to a server over a network;
receiving and processing the one or more second context fence parameters of the multimedia objects by a context-fence filter controlling module to detect a second context fence state;
identifying the second context fence state of the multimedia objects by the context-fence filter controlling module based on the one or more second context fence parameters of the multimedia objects;
generating one or more second context-fence filters by the context-fence filter controlling module based on the identified second context fence state of the multimedia objects;
enabling the user to apply at least one of: the one or more first contextual fence filters; and the one or more second contextual fence filters on the one or more computing devices; and
detecting an application state of at least one of: the one or more first contextual fence filters; and the one or more second contextual fence filters on the multimedia objects thereby generating rewards to the user by the context-fence filter controlling module.

20. A computer program product comprising a non-transitory computer-readable medium having a computer-readable program code embodied therein to be executed by one or more processors, said program code including instructions to:
monitor multimedia objects by a context-fence filter generation module on one or more computing devices in real-time;
detect one or more first context fence parameters of the multimedia objects by a context-fence filter generation module on the one or more computing devices;
identify a first context fence state based on the detected one or more context first fence parameters by the context-fence filter generation module;
generate one or more first contextual fence filters based on the first context fence state of the multimedia objects by the context-fence filter generation module;
store the one or more first contextual fence filters in a memory and enable a user to apply the one or more first contextual fence filters to the multimedia objects by the context-fence filter generation module on the one or more computing devices;
transmit one or more second context fence parameters of the multimedia objects from the one or more computing devices to a server over a network;
receive and process the one or more second context fence parameters of the multimedia objects by a context-fence filter controlling module to detect a second context fence state;
identify the second context fence state of the multimedia objects by the context-fence filter controlling module based on the one or more second context fence parameters of the multimedia objects;
generate one or more second context-fence filters by the context-fence filter controlling module based on the identified second context fence state of the multimedia objects;
enable the user to apply at least one of: the one or more first contextual fence filters; and the one or more second contextual fence filters on the one or more computing devices;
detect an application state of at least one of: the one or more first contextual fence filters; and the one or more second contextual fence filters on the multimedia objects; and
generate rewards to the user by the context-fence filter controlling module on one or more computing devices.
